(19) United States
(12) Patent Application Publication
(10) Pub. No.: US 2013/0073555 A1
(43) Pub. Date: Mar. 21, 2013

(54) Method and system for improving interaction between participants of online networks

(71) Applicants: Elan Bitan, Florham Park, NJ (US); John O'Brien, Florham Park, NJ (US)

(72) Inventors: Elan Bitan, Florham Park, NJ (US); John O'Brien, Florham Park, NJ (US)

(21) Appl. No.: 13/507,556

(22) Filed: Jul. 10, 2012

Related U.S. Application Data
(60) Provisional application No. 61/572,150, filed on Jul. 13, 2011.

(51) Int. Cl. G06F 17/30

(52) U.S. Cl. 707/740; 707/E17.046

(57) ABSTRACT

The present invention presents a system and method for improving interaction between participants of Online Networks increasing the probability of a match connecting Online Networks and Marketplace Participants, using conventional retrieval technology.

### BACKGROUND OF THE INVENTION

1. Field of the Invention

The present invention relates to method and system for improving interaction between participants of online networks.

2. Description of the Prior Art

The Internet World Wide Web including private intranet pages (“Web”) has been growing at an exponential rate resulting in huge increases in both the volume as well as the variety of available pages of information content. This informational content (“Content”) includes any associated viewable pages, shopping websites documents, corporate or other databases, private intranet pages searchable by an instance of a search engine, data files, audio files, graphic files, video files, or other type of files, otherwise known as objects (“Objects”). Companies and organizations, (“Companies”), which offer products or services to purchase or lease or buy or barter, or otherwise acquire for other consideration are most often described in unstructured formats and in shallow descriptions and minimally constructed classification trees. Where significant Content is available describing a Company or its offerings such Content is usually unstructured and may be represented by one or more information Objects deposited somewhere on the Web or in a database system. Companies and individuals which interact and communicate with each other concerning the exchange of information about, or the purchase, sale, lease, or barter of products or services are known as market participants (“Market Participants”). Any physical or virtual space where a business transaction is agreed or information about a product or service is presented is a marketplace (“Marketplace”). A subset of the Web which may impose, or typically imposes, some membership rules concerning communications and or membership, and or display rules, and where members share some common interest or connection, is known as a Online Network, (“Online Network”). Examples of the type of Online Networks are Commerce Networks (Ebay), Social Networks (Myspace, Facebook), Professional Networks (Linked In), Image/Video Networks (Flicker, YouTube), Subscription Networks (Rhapsody), and the Web itself. A Marketplace application, or application, (“application”) is a Company run business or endeavor with a particular purpose or focus and a Web or electronic network presence. Some typical examples might be Yellow Pages or business intelligence companies or a shopping application which presents a plurality of sites matched to the same product or model number.

This significant increase in Content, coupled with the inherently decentralized nature of the Web, has resulted in generating a number of various search engines (“Search Engine”) which periodically index Content electronically, including on the Web and which may maintain catalogs, indexes and databases of various Content locations. These Search Engines permit searchers to obtain the Web or other addressable locations of various Content in response to search requests submitted by the user, including searches over the Web.

The Content descriptions of most of Company businesses are not structured on the Web. While such Content may be very detailed and in many cases vast, it varies to a great degree and is particularly fragmented as presented in Online Networks and also usually only a master or broad category is presented.

Prior art descriptions of Companies are unorganized, and largely unstructured. For example, the Coca Cola Company may be under a “Food and Beverage” categories in Online Networks like that found on the Social Network, Facebook, but in reality there are many categories this company may be relevant such as Soft Drinks, Sports Drinks, Energy Drinks, etc, etc.

### SUMMARY OF THE INVENTION

It is the object of the present invention to construct from one or more sources a structured set of categories and sub-categories for use by one or more applications which use the increased relevancy of the constructed categories to connect two or more Market Participants together for the purposes of improved interaction including possible transactions between Market Participants.

It is a further object of the present invention to collect application query related information and learn from application interactions.

It is a further object of the present invention to provide a means of translating the language, linguistic system, or data format, of the different catagorized results into a different language, or format, and to then provide these translated results to at least one Market Participant.

### BRIEF DESCRIPTION OF THE DRAWINGS

Features and advantages of the present invention will become apparent to those skilled in the art from the following description with reference to the drawings, in which:

FIG. 1 is a diagrammatic presentation of system for the present invention.

FIG. 2 is a functional presentation of system for the present invention.

### DETAILED DESCRIPTION OF INVENTION AND THE PREFERRED EMBODIMENTS

One major aspect of the present invention is an ability to improve interaction between a Company and an individual, or a Company and a Company, when one or more are users of Online Networks and are acting as Market Participants.

To better appreciate the present invention, we first discuss some deficiencies with the prior art that we seek to correct.

There is a need to define more specific categories and sub categories for companies, businesses, and service providers in order to facilitate improved connections between buyers and sellers, or providers and users. In the example regarding the Coca Cola Company above, simply relegating the company under a “Food and Beverage” category in Online Networks, ignores the possibilities that there are many categories this company may be relevant such as Soft Drinks, Sports Drinks, Energy Drinks, to cite just a few examples. And if a Company were to be listed in each relevant category relative to a range of probable user contexts, then it would be then possible to match up user query requests to context correct Company Content.

By using different tools and algorithms and clustering technology, and running those tools on top of collected data, in other words to operate those tools such as to use the collected data, such as data from multiple sources like the company website, meta tags, Online Networks company pages or product descriptions, blogs, and similar data sources, it is possible to construct a more meaningful set of categories and sub categories into which the Company Content might be more easily accessed. Such improved categories make it possible to connect searchers with relevant information about Companies and Content relative to their particular or individual context. Expressed another way, it is possible for applications to match Market Participants where the matching reflects improved relevance relative to the context of the application query.

It is then possible to expand such categories using one or more thesaurus and an algorithmic taxonomy builder process, discussed below.

Then, by using live dictionaries the categories are reduced to a more meaningful set. In this way we achieve more meaningful occurrences and usages that results in improved context meaning.

A user searching the improved categorized database with one or more keywords would then be able to isolate relevant Companies and offerings quickly to satisfy user requests.

The present invention makes it possible to match or connect Online Networks and Marketplace Participants, through applications and or using conventional retrieval technology, because of the improved categories and their description. The present invention includes a unique and novel process using the method of data collection, clustering, algorithmic category and sub-category construction, category expansion, category cleaning, indexing and storing, and decoding relevancy scores which can then facilitate matches and possible access to relevant Companies and Content in response to interactive queries.

In the following description, reference is made to the accompanying drawings which form a part hereof, and which illustrate several embodiments of the present invention. Reference is also made to an issued U.S. patent and a filed and published U.S. patent application by the same inventors. It is understood that other embodiments may be utilized and structural and operational changes may be made without departing from the scope of the present invention.

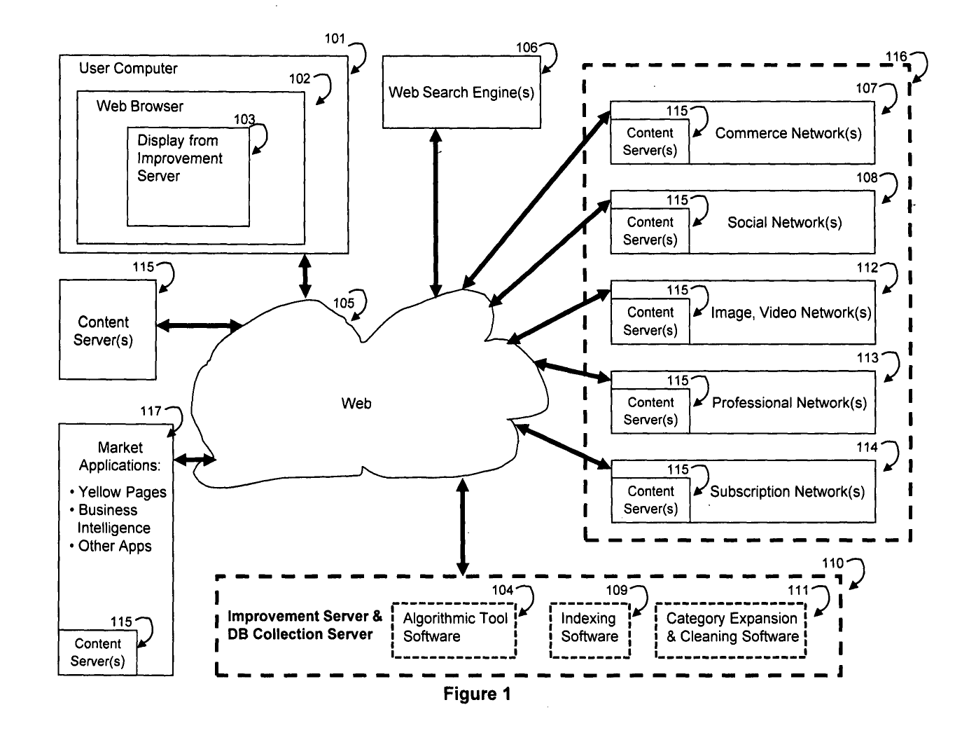

In one of the preferred embodiments of the present invention, FIG. 1 depicts a diagrammatic presentation of system for the present invention. This figure illustrates a user computer 101 in which hosts a Web browser 102 and the browser displays presentation data 103 from the present invention Improvement Server and DB Collection Server, 110.

The Web 105 includes multiple connections between the user computer 101 and the Improvement Server and DB Collection Server 110. Also connected to the Web 105 are one or more Content servers 115, one or more Web Search Engines 106, and one or more Online Networks 116. Note that as shown in FIG. 1 the Online Networks 116 includes possible members such as Commerce Networks 107 (eg.: Ebay), Social Networks 108 (Eg.: Myspace, Facebook), Professional Networks 113 (Eg.: Linked In), Image/Video Networks (Eg.: Flicker, YouTube), Subscription Networks (eg.: Rhapsody), and the Web 05 itself Note also that each of these contain a plurality of Content Servers 115.

Market applications 117 are shown in FIG. 1 as it is anticipated that these applications will make use of the present invention by matching user queries to more structured, more comprehensive, more detailed, less fragmented, and therefore more relevant category descriptions.

Note that The Improvement Server and DB Collection Server 110 performs a data collection effort as described below. This data collection effort is performed repeatedly on the Online Networks element 116. The aggregated results, at any point in time, represent results that might be considered to have been run in the background. It is these aggregate results that Market Applications 117 use when they query the improved category descriptions. To signify that there is an asynchrony in time between the data collection and refinement efforts of The Improvement Server and DB Collection Server 110, and the use of that refined data, elements 110 and 116 are shown in FIG. 1 using dashed lines instead of solid lines.

The Improvement Server and DB Collection Server 110 embodies Algorithmic Tool Software 104, Indexing Software 109, and Category Expansion and Cleaning Software 111.

The Algorithmic Tool Software 104 contains a clustering capability of the type described in U.S. Pat. No. 7,617,193. Those skilled in the art will recognize that any clustering capability which delivers similar or analogical results to 7,617,193 is a fitting substitute. Such a clustering capability can be use to jumpstart the information collection process about a company by simply searching for generic terms like “product(s)”, “service(s)”, “brand(s)”, “product lists”, “product descriptions” etc. For example: use of the 7,617,193 clustering tool results in the following results—for the Coca Cola example cited earlier: Coca Cola, Diet Coke, Sprite, Fanta, Juice drink, energy drink, and a link to 3800 beverage names used by Coca Cola World Wide.

The Algorithmic Tool Software 104 starts with a data collection effort. The Algorithmic Tool Software uses the meta tags, publically available from the Company website, and combines this with description information from one or more Online Networks 116, and optionally one or more blog product discussions. Clustering analysis is then run on these sources and, as described above, including using the meta tags and high frequency count words from the associated Content of collected data, as clustering keywords. In this way we can algorithmically construct categories and sub-categories.

The Category Expansion and Cleaning Software 111 starts with the set of created categories and uses a thesaurus and the related word taxonomy builder described in Ser. No. 12/590,558, or equivalent, to expand the categories and sub categories. After such automatic construction and expansion, these categories are algorithmically cleaned using an online dictionary to focus on noun words. A brief manual review is then performed making any adjustments as necessary.

Indexing Software 109, is used to create an inverted index between the category entries and source Content. Relevancy scoring, similar to the type described in U.S. Pat. No. 7,617,193, is computed and stored along with the indexing software. This scoring info facilitates providing users with a relevant match to a product or Company or access to relevant Content.

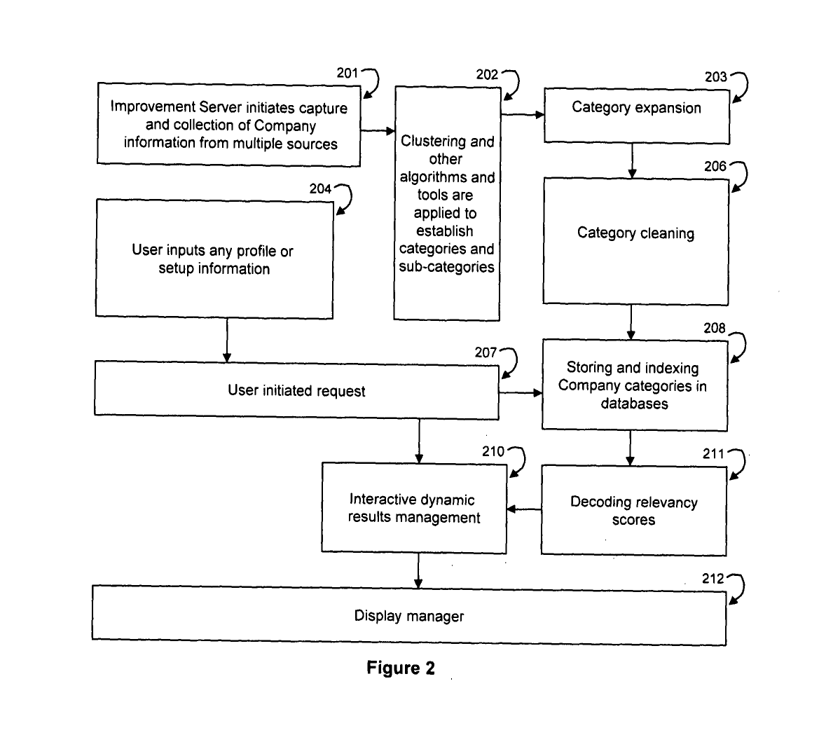

FIG. 2 is a functional presentation of system for the present invention. This figure shows the various steps in the process of the present invention. The Improvement Server 201 initiates capture and collection of Company information. This Company information is then clustered and processed 202 by other algorithmic tools described above to create categories and sub categories.

Categories are then expanded 203 using automatic taxonomy tools discussed above. The completed and expanded categories are then cleaned 206 via a manual review and adjustment, and afterwards they are indexed and stored 208. This storage also includes relevancy scores.

By logging, collecting, and analyzing query and transaction information from applications which match a query with relevant categories, it is possible to learn from application interactions.

The inventors note that it would be possible to automatically translate the categories and the information they contain to another language, linguistic system, or data format. Therefore it is readily possible to access different catagorized results and present them in a different language, or format, and to then provide these translated results to at least one Market Participant.

When queried the database can make highly relevant matches between Market Participants. The user query keyword is used to decode 211 the most relevant responses. These queries can be dynamic and interactive 210 against the scored results stored in the database. All results of these queries are displayed via the user's Display Manager 212.

User initiated requests 207 or queries interrogate the categories stored in the database 208, but they may also interactively interact with temporary stored results of query or queries in 210. These user requests from 207 also reflect any profile or setup information 204 previously entered.

Nothing in this specification should be understood to limit this invention with the WEB browser or the internet. The WEB is merely an example of a convenient set of Online Networks. The principles of this invention might be applied to assisting searches of a local disk drive, or a Network Attached Storage, or an NAS, device, or a Storage Area Network, SAN system, or some other storage system. Nothing in this specification is intended to tie the present invention to only the internet, or only another set of Online Networks. It is anticipated an embodiment of the invention may span both.

In summary, the present invention presents a system and method for providing an approach for data collection, a way to clustering that data, a method of algorithmic creation of categories and sub-categories, a way for category expansion, a way for category cleaning, and the indexing and storing of relevancy scores and access paths, and decoding relevancy scores and facilitating matching and access to relevant Content in response to interactive queries.

1. A method of connecting Market Participants and Online Networks, through applications and or using conventional retrieval technology comprising the steps of:
a) collecting data from one or more sources including Online Networks, Company websites, blogs, meta tags;
b) using a clustering technology to find subcategories;
c) cleaning the categories;
d) indexing and storing the categories; and
e) decoding relevancy scores to facilitate matches by applications.

2. A method for connecting Market Participants and Online Networks according to claim 2, further including the step of expanding categories.
